(19) United States
(12) Patent Application Publication
(10) Pub. No.: US 2013/0191243 A1
(43) Pub. Date: Jul. 25, 2013

(54) TERMINAL AND A CONTROL METHOD THEREOF

(71) Applicant: LG Electronics Inc., Seoul (KR)

(72) Inventors: Mijin Jung, Seoul (KR); Daejeong Kang, Seoul (KR); Jahee Sohn, Seoul (KR); Wonhee Cheong, Seoul (KR); Shinjae Jeong, Seoul (KR); Yongjoon Kim, Seoul (KR)

(73) Assignee: LG Electronics Inc., Seoul (KR)

(21) Appl. No.: 13/734,403

(22) Filed: Jan. 4, 2013

Related U.S. Application Data
(60) Provisional application No. 61/583,625, filed on Jan. 6, 2012.

(51) Int. Cl. G06Q 30/06

(52) U.S. Cl. CPC G06Q 30/0633
USPC 705/26.8

(57) ABSTRACT

A terminal and a control method thereof are disclosed. The terminal that may be built in or detached from a refrigerator comprises a display module displaying information on food on a screen; and a controller displaying a shopping list on food buying, providing detailed shopping information of food selected from the displayed shopping list, and transmitting and receiving information on order and payment of the corresponding food to and from an online mart linked with the terminal.

This application claims the benefit of the U.S. Provisional Patent Application No. 61/583,625, filed on Jan. 6, 2012, which is hereby incorporated by reference as if fully set forth herein.

### BACKGROUND OF THE INVENTION

1. Field of the Invention

The present invention relates to a terminal and a control method thereof, and more particularly, to a terminal that provides a user with shopping information to allow the user to buy a corresponding item, and a control method of the terminal.

2. Discussion of the Related Art

Generally, home appliances such as a cooking machine, a refrigerator and a washing machine perform their suitable functions to provide a user with convenience.

Recently, a ‘home network’ which connects home appliances to one network has been provided, and the user could remotely control the home appliances through the home network.

Also, with the development of a smart phone, various applications, which can monitor the status of the home appliances through the home network and drive the home appliances, have been developed, and efforts for improving user interfaces of the applications have been made.

Particularly, since the refrigerator serves to store food, it is likely that a user recognizes that correlation between food information and the refrigerator is high. Accordingly, a desire of a consumer who desires to acquire and process information on food stored in the refrigerator through a terminal has been increased.

### SUMMARY OF THE INVENTION

Accordingly, the present invention is directed to a terminal and a control method thereof, which substantially obviate one or more problems due to limitations and disadvantages of the related art.

An object of the present invention is to provide a terminal and a control method thereof, in which a user may receive a list of food of which buying is required, through the terminal.

Another object of the present invention is to provide a terminal and a control method thereof, in which a user may order food and pay for the ordered food through the terminal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a terminal that may be built in or detached from a refrigerator comprises a display module displaying information on food on a screen; and a controller displaying a shopping list on food buying, providing detailed shopping information of food selected from the displayed shopping list, and transmitting and receiving information on order and payment of the corresponding food to and from an online mart linked with the terminal.

In another aspect of the present invention, a control method of a terminal that may be built in or detached from a refrigerator comprises the steps of displaying a shopping list on food buying for a user; detecting food selected by the user from the shopping list; receiving information on the selected food from an online mart linked with the terminal; and processing order information and payment information input by the user.

According to the present invention, since the user may receive a list of food of which buying is required, through the terminal, user convenience is improved.

Also, since the user may order and pay for food through the terminal, an inconvenience caused as the user directly visits a mart may be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a refrigerator to which the present invention may be applied;

FIG. 2 is a control block diagram illustrating a terminal according to the present invention;

FIG. 3 is a control flow chart illustrating a terminal according to the present invention;

FIG. 4 is a diagram illustrating a procedure of displaying a shopping list in a terminal according to the present invention;

FIG. 5 and FIG. 6 are diagrams illustrating a procedure of selecting food from a terminal according to the present invention and receiving related information from an online mart;

FIG. 7 and FIG. 8 are diagrams illustrating a procedure of inputting order information in a terminal according to the present invention; and

FIG. 9 and FIG. 10 are diagrams illustrating a procedure of inputting payment information in a terminal according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Elements of the present invention may be shown in the drawings in exaggerated sizes or shapes for conciseness and convenience of description. Also, the terms defined especially considering the embodiments of the present invention may be modified depending on intention of a person skilled in the art, practices, or the advent of new technology. Also, in special case, the terms mentioned in the description of the present invention may be selected by the applicant at his or her discretion, the detailed meanings of which are described in relevant parts of the description herein. Accordingly, the terms used herein should be understood not simply by the actual terms used but by the meaning lying within and the description disclosed herein.

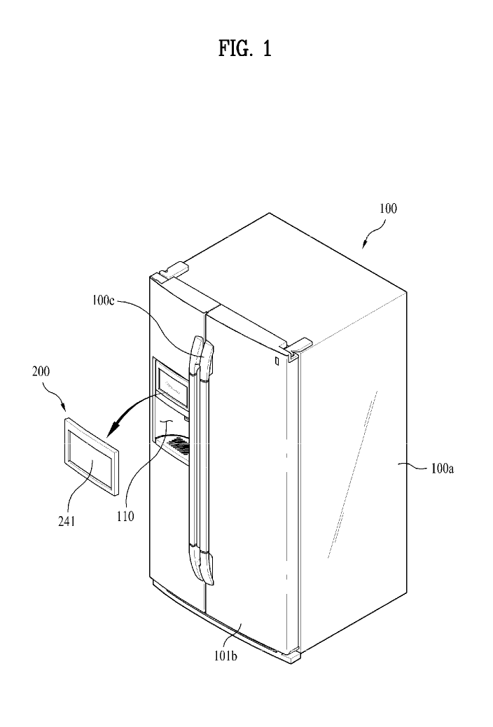

As shown in FIG. 1, a refrigerator 100 to which the present invention may be applied includes a main body 100a, a door 101b provided on a front surface of the main body 100a, and a handle 100c fixed to the door 101b.

The door 101b may be provided with a dispenser 110 that may dispense cool water or ices and a terminal 200 that may provide a user with various kinds of information such as food stored in the refrigerator and transmit information input by the user to another device.

Preferably, the terminal 200 includes a display module 241 that displays predetermined information and allows a predetermined command to be input by a touch.

Preferably, a touch screen that allows input and display at the same time is used as the display module 241. However, a general display module having a display function only and a button type input device provided separately from the display module may be provided.

The terminal 200 may be fixed to the front surface of the door, and may be provided detachably so that the user may fix or detach the terminal 200 to or from the refrigerator if necessary.

On the other hand, the terminal 200 may be provided separately from the refrigerator in the form of a smart phone, whereby the user may shift the terminal 200 to a remote place where the refrigerator 100 is not provided.

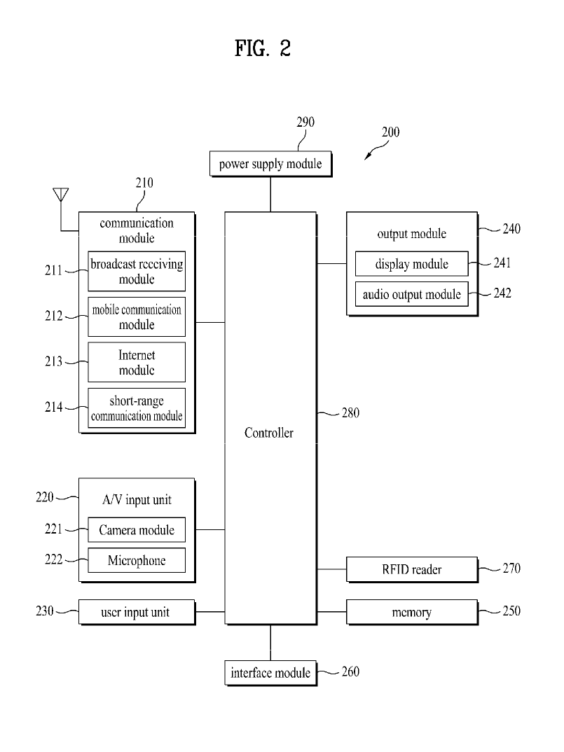

Referring to FIG. 2, the terminal 200 according to the present invention includes a communication module 210, an audio/video (A/V) input module 220, a user input module 230, an output module 240, a memory 250, an interface module 260, an RFID reader 270, a controller 280, and a power supply module 290. It is to be understood that the modules or elements shown in FIG. 1 are not required essentially. Accordingly, the terminal 200 having modules or elements more than or smaller than the modules or elements shown in FIG. 1 may be provided.

Hereinafter, the aforementioned modules or elements will be described.

The communication module 210 may include one or more modules that enable Internet between the terminal 200 and a wireless communication system or at Internet network where the terminal 200 is located.

For example, the communication module 210 may include a broadcast receiving module 211, a mobile communication module 212, an Internet module 213 and a short-range communication module 214.

The broadcast receiving module 211 receives a broadcast signal and/or broadcasting related information from an external broadcast management server through a broadcast channel under the control of the controller 280 and plays the broadcast signal and/or the broadcasting related information in the display module 241.

The mobile communication module 212 transmits and receives a radio signal to and from at least one of a base station, an external terminal and a server on a mobile communication network. The radio signal may include an audio signal, a video communication signal, or various types of data based on transmission and reception of text/multimedia messages.

The Internet module 213 means a module for wire/wireless Internet access, and WLAN (Wireless LAN) (Wi-Fi), Wibro (Wireless broadband), Wimax (World Interoperability for Microwave Access), and HSDPA (High Speed Downlink Packet Access) may be used as the radio Internet technology.

The short-range communication module 214 means a module for short-range communication. Bluetooth, RFID (Radio Frequency Identification), infrared communication (IrDA, infrared Data Association), UWB (Ultra Wideband), ZigBee, etc. may be used as the short-range communication technology.

The audio/video (A/V) input module 220 is for audio signal input or video signal input, and may include a camera 221 and a mike 222.

The camera 221 processes image information such as still image or moving picture image, which is obtained by an image sensor in an image communication mode or camera mode. The processed image information may be displayed in the display module 241.

The image data processed by the camera 221 may be stored in the memory 250 or may be transmitted to the outside through the communication module 210. Two or more cameras 221 may be provided depending on its usage condition.

The mike 222 receives an external sound signal through a microphone in a communication mode, recording mode, or voice recognition mode and processes the received sound signal to electrical audio data.

The user input module 230 generates input data for allowing the user to control the operation of the terminal 200. The user input module 230 may include a key pad, a direction key, a dome switch, a touch pad (static pressure/electrostatic), a jog wheel, and a jog switch.

The output module 240 is intended to generate the output related to vision or hearing, and may include the display module 241 and a sound output module 242.

The display module 241 displays (outputs) information processed by the terminal 200.

For example, if the display module 241 displays information related to the terminal 200 and the refrigerator 100 is displayed, it displays the information related to the refrigerator 100 in the form of a user interface (UI) or a graphic user interface (GUI) such as widget and icon.

The aforementioned display module 241 may include at least one of a liquid crystal display (LCD), a thin film transistor liquid crystal display (TFT LCD), an organic light-emitting diode (OLED), a flexible display, and a 3D display.

If the display module 241 and a sensor (hereinafter, referred to as a ‘touch sensor’) that senses touch action form a mutual layer structure (hereinafter, referred to as a ‘touch screen’), the display module 241 may be used as an input device in addition to an output device.

The touch sensor may have a type such as a touch film, a touch sheet, and a touch pad, for example.

The touch sensor may be configured to convert a pressure given to a specific portion of the display module 241 or capacitance occurring in the specific portion of the display module 241 to an electrical input signal. The touch sensor may be configured to detect even a touch pressure as well as a touched position and a touched area.

If there is a touch input to the touch sensor, signal(s) corresponding to the touch input are forwarded to a touch controller (not shown). The touch controller processes the signal(s) and then corresponding data to the controller 280. As a result, the controller 280 may recognize which portion of the display module 241 has been touched.

The sound output module 242 outputs data which include audio provided in the memory 250, or outputs sound for notifying a user of action status related to the refrigerator 100. The sound output module 242 may include a receiver, a speaker and a buzzer.

The memory 250 may store a program for processing and control of the controller 280, or may include information related to food kept in the refrigerator. Also, the memory 250 may include information on expiration date of food kept in the refrigerator.

Also, the memory 250 stores graphic data of various messages and information, which are provided to the user in various visual effects.

The aforementioned memory 250 may include a storage medium of at least one of a flash memory type, a hard disk type, a multimedia card micro type, a card type memory (e.g., a Secure Digital (SD) or eXtreme Digital (XD) memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disc, an optical disc, etc.

The interface module 260 serves to a communication path with all the external devices connected with the terminal 200 for a refrigerator. The interface module 260 receives data from the external device or is supplied with a power source, and forwards the power source to each module inside the terminal 200 or allows the data inside the terminal 200 to be transmitted to the external device.

For example, the interface module 260 may include a wire/wireless headset port, an external charger port, a wire/wireless data port, a memory card port, a port connecting a device having an identification module, an audio input/output (I/O) port, a video I/O port, and an earphone port.

The controller 280 generally controls an overall operation of the terminal 200.

The power supply module 290 receives the external power source supplied through the interface module 260 and supplies the power source required for the operation of each module under the control of the controller 280.

Various embodiments described herein may be implemented in a recording medium that may be read out by a computer or its similar device, by using software, hardware, or their combination.

If the embodiments are implemented by hardware, the embodiments may be implemented by at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electrical units for performing functions.

In some cases, the embodiments described in this specification may be implemented by the controller 280.

According to a software configuration, embodiments of procedures and functions described in the present invention may be implemented by separate software modules. Each of the software modules may perform one or more functions and operations described in this specification.

A software code may be implemented by a software application written in a proper program language. The software code may be stored in the memory 250 and may be implemented by the controller 280.

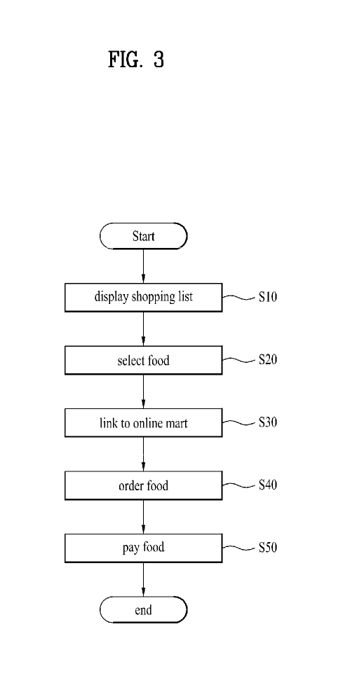

FIG. 3 is a control flow chart illustrating a terminal according to the present invention. Hereinafter, the control operation of the terminal will be described with reference to FIG. 3.

The user may recognize a shopping list on food buying, receive detailed shopping information on food selected from the displayed shopping list, and transmit and receive information on order and payment of corresponding food by interacting with an online mart, through the terminal 200 according to the present invention. A detailed control flow will be described.

First of all, the shopping list on food may be displayed in the display module 241 (S10).

At this time, the shopping list may include information stored in the terminal 100 and information stored outside the terminal 200, that is, information stored in the server or refrigerator of the terminal 200.

Meanwhile, the shopping list may mean a list of food promoting buying of the user. The user may recognize what food will be required to be bought currently, through the shopping list.

The shopping list may include information on food of which expiration date is shorter than a predetermined date. In the food kept in the refrigerator, the food of which expiration date is imminent will be required to be newly bought by the user for sanitary reasons. Accordingly, the shopping list may promote re-buying of the corresponding food to the user.

At this time, the predetermined date of the expiration date may be set or changed by the user or various persons such as a manufacturer of the terminal.

Also, the shopping list may include information on food source required for a recipe of a cooking menu which the user desires to cook. For example, if the user desires to cook special food such as steak, information on related food for cooking the corresponding steak, such as beef, may be provided to the user. The recipe desired by the user may be selected by the user or may be recommended to the user automatically by the terminal.

The user may select food of which additional information or buying is required, from the food provided by the shopping list. At this time, the terminal 200 may sense what the food selected by the user is (S20).

Information related to the food selected by the user may be provided to the user through the online mart linked with the user through a network (S30).

At this time, the information provided to the user may include various kinds of information such as food stock, food price, and the origin place of food.

The user may order the corresponding food through the terminal 200 (S40). At this time, various kinds of information such as delivery place and delivery date may be input to the terminal 200 by the user.

The user may pay for the corresponding food through the terminal 200 (S50). At this time, the user may pay the online mart through various credit cards.

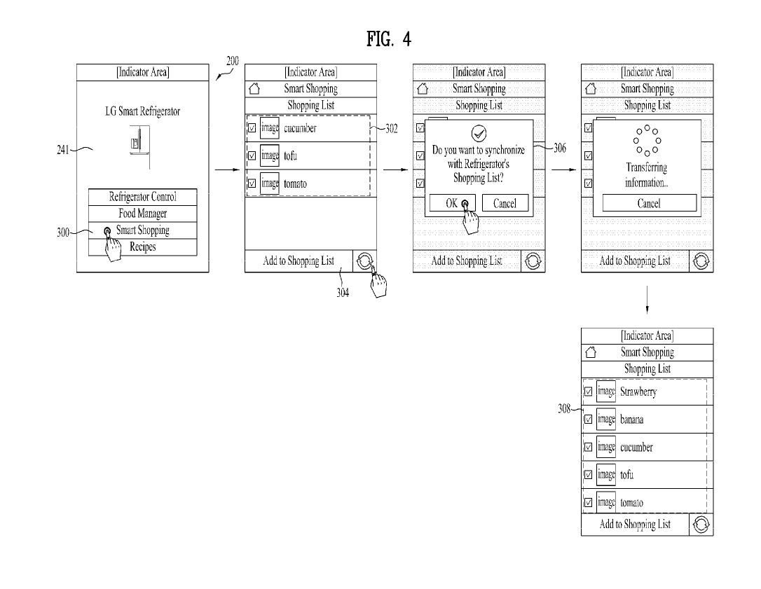

FIG. 4 is a diagram illustrating a procedure of displaying a shopping list in a terminal according to the present invention. Hereinafter, it is assumed that the display module 241 is implemented as a touch screen. Hereinafter, the procedure of displaying a shopping list in the terminal will be described with reference to FIG. 4.

An input window 300 for allowing the user to input a command to display the shopping list on a screen of the display module 241 is provided on an initial screen of the display module 241.

At this time, in addition to the input window 300, input windows for inputting various other commands such as detailed control of the refrigerator and food management may exist on the initial screen of the display module 241.

If the user selects the input window 300, the shopping list is displayed to the user. At this time, the shopping list displayed to the user is the shopping list already stored in the terminal 200. The shopping list already stored in the terminal 200 is displayed in a region 302 for displaying the corresponding shopping list. Meanwhile, the shopping list already stored in the terminal 200 may be obtained on the basis of the result of the input window 300 previously used by the user.

The shopping list already stored in the terminal 200 means information that may be provided to the user even though the terminal 200 accesses another external server and no information is transmitted and received.

In the meantime, a region 304 requesting the shopping list stored outside the terminal 200 is provided below the region 302 for displaying the shopping list already stored in the terminal 200. The user may update the shopping list stored inside and outside the terminal 200 by selecting the region 304.

In the meantime, the shopping list stored outside the terminal 200 may mean the shopping list forwarded to the terminal 200 by data transmission and reception of the terminal 200. The user may change the information on the food through another computer or another terminal not the terminal 200, and the shopping list stored outside the terminal 200 may include this information on the food.

The outside of the terminal 200 may include a server that may perform communication with the refrigerator or the terminal 200. In other words, the information on the shopping list may partially be stored in the refrigerator or the external server, and its related contents may be updated to a recent version in accordance with selection of the user.

The user may display the final shopping list in the display module 241 by synchronizing the shopping list stored inside the terminal 200 with the shopping list stored outside the terminal 200. At this time, a selection input window 256 that allows the user to select whether to synchronize a plurality of shopping lists with one another is displayed to the user, and the user may command whether to synchronize the shopping lists with one another, through the selection input window.

Finally, the display module 241 is provided with a region 308 where the final shopping list is displayed. In other words, the final shopping list may be provided to the user in such a manner that the shopping lists distributed to several portions are incorporated into one.

In other words, the user may access the shopping list by using various media such as a computer or refrigerator in addition to the terminal, and may generate shopping lists of various versions.

However, the terminal may provide the user with the shopping list of the latest version by incorporating the shopping lists of various versions with one another.

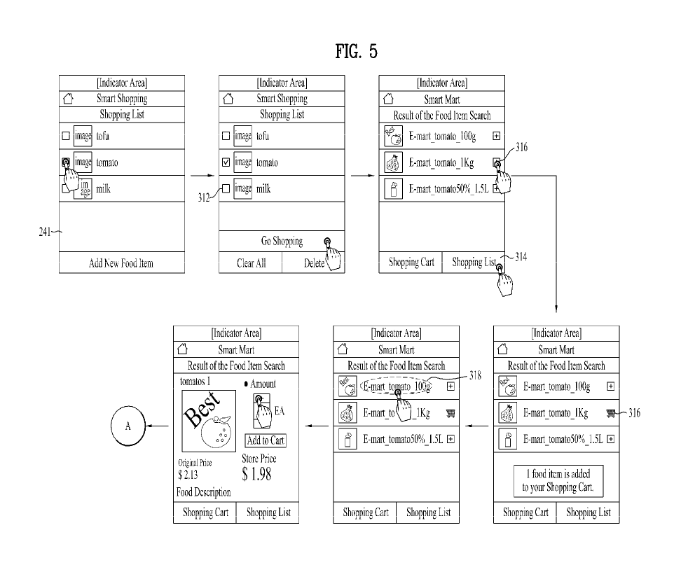

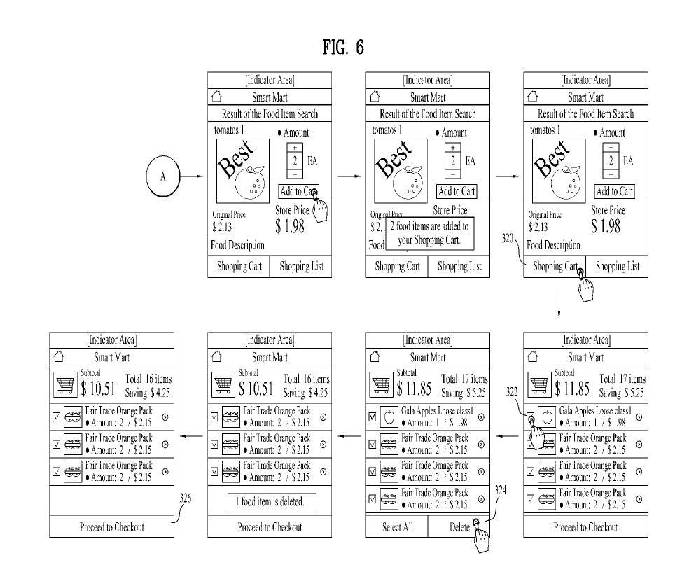

FIG. 5 and FIG. 6 are diagrams illustrating a procedure of selecting food from a terminal according to the present invention and receiving related information from an online mart. Hereinafter, this procedure will be described with reference to FIG. 5 and FIG. 6.

The user may select desired food from the shopping list shown in the display module 241 to obtain detailed information of the food. In other words, the controller 280 may determine whether the user desires to search for detailed information of the corresponding food, depending on whether the user has checked a check box 312.

If the user checks the check box 312 corresponding to the desired food, detailed information on the corresponding food from the online mart is provided to the user.

At this time, information on the corresponding food may be provided from a plurality of online marts. In other words, product information of various online marts may be provided for one food, and the user may select a product of a desired online mart.

In a state that detailed information of food is provided, the user may select a shopping list input window 314. In this case, since the user may change checking of the check box 312, he/she may change food desired to search for detailed information.

In the meantime, the user may select an icon 316 to allow desired food to be managed in a separate order list. The icon 316 may display whether the desired food of the user is managed in the order list depending on selection of the user.

On the other hand, may select a text display region 318 for the corresponding product. If the user selects the text display region 318, more detailed imaged and information may be displayed in the corresponding product unlike the selection system of the icon 316.

The user may input information on the number of corresponding products. Also, in a state that the detailed image and information on the corresponding product are displayed, the corresponding product may be managed by the order list.

If the detailed information on the desired product is provided to the user, the user may select an input region 320 to identify food listed in the order list. If the input region 320 is selected, the user may identify the list of the product listed in the order list.

The user may select a check box 322 of each food, and may delete food of which buying is not required, through a delete window 324 after selecting the check box 322.

In the meantime, the display module 241 may display brief information on foods included in the order list. At this time, the display module 241 may display information on prices of products included in the order list together with the brief information to provide the user with convenience.

The user may identify the products included in the order list and actually perform buying of the order list. At this time, the user may input whether to perform actual buying of the products included in the order list in the controller 280 through an input window 326.

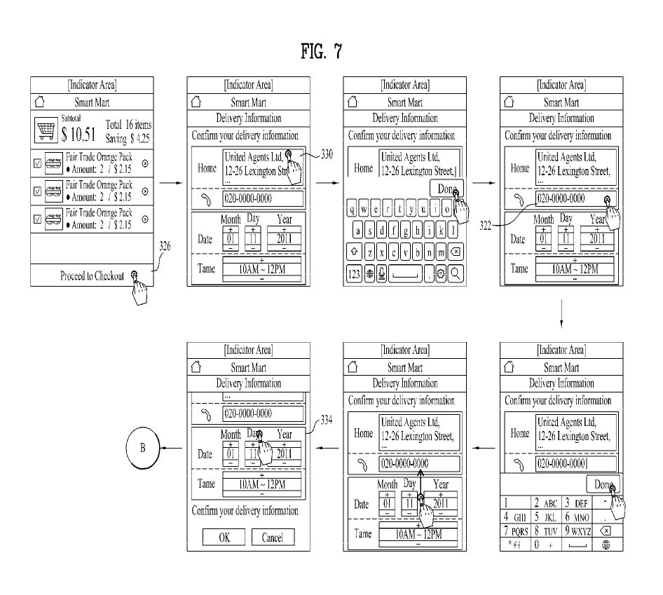

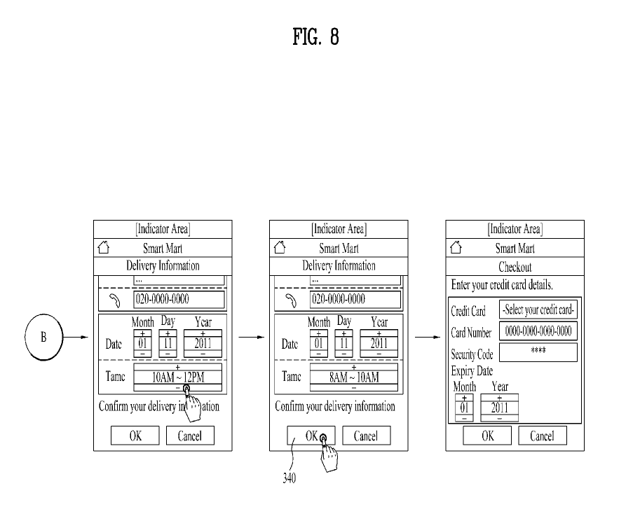

FIG. 7 and FIG. 8 are diagrams illustrating a procedure of inputting order information in a terminal according to the present invention. This procedure will be described hereinafter with reference to FIG. 7 and FIG. 8.

If the user clicks the input window 326, a detailed buying procedure of a corresponding order list may be performed. In other words, a detailed order and payment procedure of the corresponding order list is performed.

The user may identify a delivery address listed in a delivery address information confirm window 330 and review whether the corresponding information is exact. If the user desires to change a delivery address of a product, he/she may select the delivery address information confirm window 330 and then change the delivery address to a desired delivery address through a key pad.

Also, the user may identify a contact phone number listed in a contact phone number information confirm window 332 and review whether the corresponding information is exact. If the user desires to change a contact phone number of a product, he/she may select the contact phone number information confirm window 332 and then change the contact phone number to a desired contact phone number through the key pad.

And, the user may select a delivery date of the corresponding product through a delivery date confirm window 334.

Although the delivery address, the contact phone number and the delivery date have been selected sequentially in FIG. 7, they may be input differently depending on convenience of the user, and their order may be changed.

After inputting the delivery address, the contact phone number and the delivery date, the user may click an order complete window 340 and notify the controller 280 that the order of the corresponding product has been completed. If the user selects an order complete window 340, the display module 241 performs a payment procedure of the corresponding product.

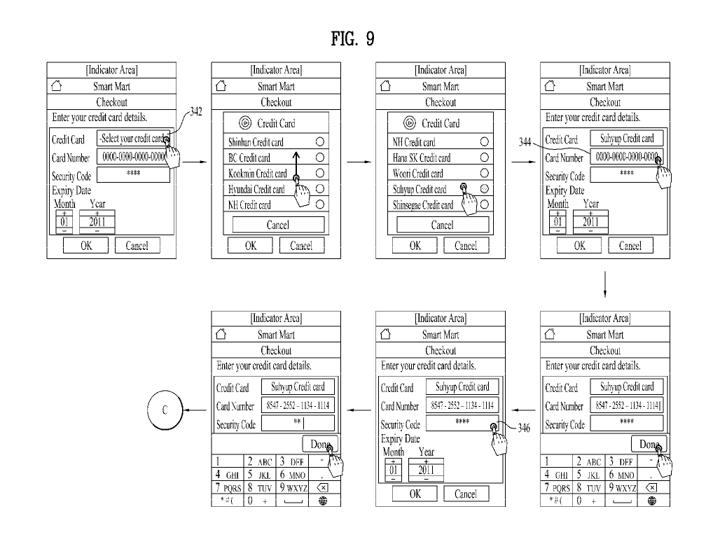

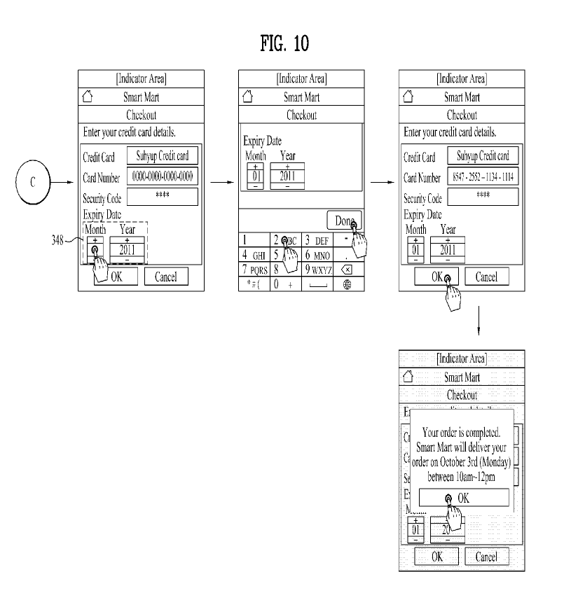

FIG. 9 and FIG. 10 are diagrams illustrating a procedure of inputting payment information in a terminal according to the present invention. This procedure will be described hereinafter with reference to FIG. 9 and FIG. 10.

The display module 241 provides the user with an information display window for payment of a product included in the order list.

The display module 241 may display a display window 342 that may display a credit card, a display window 344 that may display a card number, and a display window 346 that may display a password.

If the display window 342 is selected by the user, the user may select a desired credit card through which payment of the order list will be performed.

In the meantime, if the display window 344 is selected by the user, the user may input a card number of the selected card.

Also, if the display window 346 is selected by the user, the user may input a password by using the key pad.

In the meantime, the display module 241 may provide a display window 348 that may display expiration date of a credit card. If the corresponding display window 348 is selected, the user may change the expiration date of the selected credit card.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

What is claimed is:

1. A terminal that may be built in or detached from a refrigerator, the terminal comprising:
a display module displaying information on food on a screen; and
a controller displaying a shopping list on food buying, providing detailed shopping information of food selected from the displayed shopping list, and transmitting and receiving information on order and payment of the corresponding food to and from an online mart linked with the terminal.

2. The terminal according to claim 1, wherein the shopping list includes information stored in the refrigerator.

3. The terminal according to claim 1, wherein the shopping list includes information on food of which expiration date is shorter than a predetermined date.

4. The terminal according to claim 1, wherein the shopping list includes information on food of a selected recipe.

5. The terminal according to claim 1, wherein the display module displays a region displaying the shopping list stored in the terminal and a region requesting the shopping list stored outside the terminal.

6. The terminal according to claim 5, wherein the controller incorporates the shopping list stored in the terminal and the shopping list stored outside the terminal to one and displays the shopping list if the region requesting the shopping list stored outside the terminal is selected.

7. The terminal according to claim 1, wherein the controller receives price information on the food, which is selected from the shopping list, from an online mart.

8. The terminal according to claim 1, wherein, when the corresponding food is ordered, a delivery address and a delivery date are input to the controller.

9. A control method of a terminal that may be built in or detached from a refrigerator, the control method comprising the steps of:
displaying a shopping list on food buying for a user;
detecting food selected by the user from the shopping list;
receiving information on the selected food from an online mart linked with the terminal; and
processing order information and payment information input by the user.

10. The control method according to claim 9, wherein the shopping list displayed to the user includes information stored in the terminal.

11. The control method according to claim 9, wherein the shopping list displayed to the user includes information stored outside the terminal.

12. The control method according to claim 9, wherein the information on the selected food provided from an online mart includes price information on the food.

13. The control method according to claim 9, wherein the online mart includes a plurality of online marts.

14. The control method according to claim 9, wherein the order information includes a delivery address and a delivery date.

15. The control method according to claim 9, wherein the payment information includes information on a credit card.

16. The control method according to claim 9, wherein the step of processing order information and payment information input for the user includes the step of transmitting the order information and the payment information to the online mart.
